(19) United States
(12) Patent Application Publication
(10) Pub. No.: US 2009/0197060 A1
(43) Pub. Date: Aug. 6, 2009

(54) Compressible Fireproofing Pad and Manufacturing Method Thereof

(76) Inventor: Jae-Ku Cho, Seoul (KR)

Correspondence Address: PARK LAW FIRM, 3255 WILSHIRE BLVD, SUITE 1110, LOS ANGELES, CA, 90010, US

(21) Appl. No.: 12/303,151

(22) PCT Filed: Jun. 7, 2007
(86) PCT No.: PCT/KR2007/002761

§ 371 Date: Dec. 2, 2008

(30) Foreign Application Priority Data
Jun. 9, 2006 (KR) 10-2006-0051958

(51) Int. Cl. B32B 27/36; B32B 27/06; B05D 3/12

(52) U.S. Cl. 428/201; 428/500; 428/483; 427/292

(57) ABSTRACT

The present invention relates to a packing material for firestop systems and a manufacturing method thereof, and more particularly to a packing material for firestop systems, which comprises a thermal insulation material layer and a fireproof coating film, and a packing material for firestop systems, which further comprises a heat-resistant core material in the thermal insulation material layer, as well as a manufacturing method thereof. According to the disclosed invention, the fireproof coating film formed on the surface of the thermal insulation material layer increases the flame retardancy, waterproof property, abrasion resistance, dust resistance and restoring force of the thermal insulation material layer.

### TECHNICAL FIELD

The present invention relates to a packing material for firestop systems and a manufacturing method thereof, and more particularly to a packing material for firestop systems, which comprises a thermal insulation material layer and a fireproof coating film, and a packing material for firestop systems, which further comprises a heat-resistant core material in the thermal insulation material layer, as well as a manufacturing method thereof.

2. Background Art

Korean laws and regulations related to buildings (for example, Article 40 of the Korean Building Act, Article 2 of Enforcement Decree of the Korean Building Act, Notification No. 2005-122 (standards for the qualification and management of fireproof constructions), and the like) state standards for the performance of certain fire-resistant construction according to the use of buildings and require that the wall, bottom and the like of buildings should have a structure capable of resisting flames (higher than 1,016° C.) for longer than a given time.

The sealing of through-penetrations in building construction is important in order to prevent smoke and flames upon the occurrence of a fire in a building from rapidly spreading to an adjacent room, thus localizing or minimizing damage. Thus, construction work for sealing through-penetrations according to the performance of firestops is carried out and is called “firestop work” or “curtain wall work”. Also, in Korea and other countries, an accreditation system for testing, certifying and managing firestops is in force.

In order for through-penetrations to be lawfully recognized as firestops, the through-penetrations must pass a heat resistance test and a hose stream test, and the fire resistance ratings thereof are determined through a given heat resistance test and hose stream test in an accreditation authority.

Thermal insulation materials, such as inorganic mineral wool, glass wool and Cerak wool and polyester-based SKY VIVA, which are used as insulation materials in building construction, are widely known products and are frequently used as intermediate materials in firestops. These thermal insulation materials are excellent with respect to flame retardancy, thermal insulation, lightweight, cost, etc., depending on products, but they have high degradation, absorption and abrasion properties and can generate dust. Also, it has been known that fire protective insulation materials having high density are inflexible, and thus there is a problem in the use of these fire protective insulation materials alone as packing materials for firestop systems. Moreover, with respect to thermal resistance, the thermal insulation materials start to degrade at about 700° C. for mineral wool and at about 500° C. for glass wool, and thus these insulation materials are not suitable for use in firestops which should resist a high temperature higher than 1,016° C. For this reason, the thermal insulation materials have been used only as intermediate materials.

FIG. 1 is a cross-sectional view showing a prior firestop construction for a floor opening through which a penetrating material is passed. As shown in FIG. 1, a steel plate 20 is fixed to the lower side of a concrete slab 10 by means of, for example, a nail 21, and a thermal insulation material 30 such as mineral wool is inserted as an intermediate material into a through-penetration 11 of the concrete slab 10. Also, a fire-protective material 40 such as a fire-protective foam material or a fire-protective sealant is filled in the upper portion of the through-penetration. FIG. 2 is a cross-sectional view showing another prior firestop construction for a portion connected to a partition wall. As shown in FIG. 2, a backup material 30 is inserted into a space 51 extending from a partition wall 50, and a separate firestop material 40 such as a firestop sealant is filled outside the backup material.

In such prior construction methods, thermal insulation materials are processed in situ by workers, and thus there is a risk that the workers are exposed directly to mineral wool dust, and there is a problem in that industrial waste such as mineral wool waste excessively occurs. Also, in the prior art, the price of firestop material is high, firestop construction is complicated and requires a large number of working processes, so that excessive construction costs are incurred. Thus, in building construction sites, there is, in fact, the phenomenon that firestop construction itself is evaded. In addition, in the prior firestop construction methods, in which processes of applying a firestop material on a thermal insulation material having good absorption properties and drying the applied material should be repeated, there is a problem in that work becomes impossible in the winter season or in the case of rain.

### DISCLOSURE OF INVENTION

### Technical Problem

The present invention has been made in order to solve the above-described problems occurring in the prior art, and it is an object of the present invention to provide a packing material for firestop systems, which enables the construction of firestops to be completed at low cost in a simple manner and has improved performance compared to the prior packing materials, as well as a manufacturing thereof.

Another object of the present invention is to provide a packing material for firestop systems, the fire resistance rating of which can be freely adjusted by varying the blending ratio of raw materials and injection amount of a heat-resistant injection material, which is injected into a thermal insulation material layer in order to improve the heat resistance of the thermal insulation material, so that the packing material can show high heat resistance in a place having a wide penetration, thus making it possible to perform the quality construction of firestop systems, as well as a manufacturing method thereof.

Still another object of the present invention is to provide a packing material for firestop systems, which shortens a construction period, inhibits the generation of industrial waste such as mineral wool waste and prevents workers from damaged by mineral wool dust in construction sites, as well as a manufacturing method thereof.

Yet still another object of the present invention is to provide a packing material for firestop systems, in which a fireproof coating film formed on the surface of a thermal insulation material layer blocks the external exposure of a thermal insulation material such as mineral wool so as to prevent indoor air from being contaminated with mineral wool dust, as well as a manufacturing method thereof.

### Technical Solution

To achieve the above objects, in one aspect, the present invention provides a packing material for firestop systems, which comprises a thermal insulation material layer and a fireproof coating film formed on the surface of the thermal insulation material layer. Preferably, the packing material for firestop systems according to the present invention further comprises a heat-resistant core material in the thermal insulation material layer.

In another aspect, the present invention provides a method for manufacturing a packing material for firestop systems, the method comprising the steps of: (1) cutting a thermal insulation material layer according to specifications; (2) arranging injection pins in a heat-resistant core material-forming at a given interval, thrusting the injection pins of the frame into the thermal insulation material layer, and then taking out the injection pins from the thermal insulation material layer while injecting a heat-resistant injection material into the thermal insulation material layer through the end portion of the injection pins, thus forming a heat-resistant core material in the thermal insulation material layer in any one form of a column type, a dot type and a sheet type; and (3) applying a fireproof elastic material on the surface of the thermal insulation material layer to form a fireproof coating film. In the above manufacturing method according to the present invention, the step (3) may also be carried out prior to the step (2).

Hereinafter, a preferred embodiment of the present invention will be described in detail with reference to the accompanying drawings. In the drawings, like reference numerals denote like parts.

1. Packing Material for Firestop Systems in Fireproof Partitions

FIGS. 4 and 5 illustrate a packing material (P) for firestop system.

As shown in FIGS. 4 and 5, a thermal insulation material layer 100 is made of any one selected from among inorganic mineral wool, glass wool, Cerak (ceramic) wool, vermiculite wool, pearlite wool, and polyester-based thermal insulation materials.

Among them, mineral wool, glass wool, vermiculite wool and pearlite wool are based on mineral fibers. The polyester-based thermal insulation materials may include non-woven fabric-type SKY VIVA, which is produced by SK Chemical Company. In the prior construction method, thermal insulation material has been cut and processed by workers in building construction sites, but in the present invention, the thermal insulation material layer 100 is cut in the form of a sheet, a band or a given through-penetration material, as shown in FIG. 3, in order to manufacture the packing material (P) for firestop systems. Also, as shown in the bottom of FIG. 3, the thermal insulation material layer 100 may be in the form of a thin layer, such that the packing material (P) for firestop systems may be wound in a roll form. Preferably, the roll-type packing material (P) is cut for use in a narrow-width space between a pipe and a slab in a through-penetration. Also, when the packing material (P) for firestop systems is produced according to size within a size variation of about 30% in view of a pressing rate of about 30%, it can contribute to cost reduction due to building material specification standardization and mass production.

A fireproof elastic material is applied on the surface of the thermal insulation material layer 100 to form a fireproof coating film 200, which increases the flame retardancy, waterproof, abrasion resistance and dust resistance properties of the thermal insulation material layer 100. Also, the fireproof coating film 200 enables the thermal insulation material layer 100 to have restoring force and elasticity. Herein, the fireproof elastic material includes liquid latex, such as liquid acrylic latex or rubber latex (synthetic rubber latex or natural rubber latex), and contains, as a filler, at least one selected from among powder-type calcium carbonate (CaCo₃), aluminum hydroxide (Al(OH)₃), melamine, ammonium polyphosphate (NH₄PO₃)ₙ) and talc (magnesium silicate hydroxide; Mg₃Si₂O₁₀ (OH)₂).

In the case where the fireproof elastic material containing acrylic latex or rubber latex is applied on the surface of the thermal insulation material layer 100 to a thickness greater than a given thickness, when the thermal insulation material layer 100 undergoes pressure, the fireproof coating film 200 will exhibit the ability to recover to the original state, thus facilitating the restoration of the packing material. As the thermal insulation material layer 100 for use in firestop systems, a high-density product is mainly used in order to reinforce the weak heat resistance thereof, and in the case of mineral wool having a density of more than 100 K, it is impossible for workers to press and insert the thermal insulation material into through-penetrations directly in situ, and thus, in the prior art, work was not performed to a certified construction in situ. For this reason, in the present invention, as shown in FIG. 6, the thermal insulation material layer 100 is pressed one time or more such that it has elasticity. In addition, the fireproof coating film 200 is formed with the fireproof elastic material to increase the restoring force of the thermal insulation material 100. Thus, workers can easily apply the high-density thermal insulation layer 100.

Preferred examples of the fireproof elastic coating material for forming the fireproof coating film 200 may include a coating material comprising, as a binder, 60 wt % of liquid acrylic latex, and as fillers, 23 wt % of calcium carbonate, 12 wt % of aluminum hydroxide, 3 wt % of melamine and 2 wt % of ammonium polyphosphate (composition 1), or a coating material comprising, as a binder, 68 wt % of liquid synthetic rubber latex (SBR), and as fillers, 15 wt % of calcium carbonate, 8 wt % of aluminum hydroxide, 5 wt % of talc and 4 wt % of ammonium polyphosphate.

The acrylic latex or synthetic rubber latex is a flammable material and is prevented from burning due to the addition of the powder-type flame-retardant components. Thus, the latex component itself is flammable, but because the flame-retardant components having the respective properties are added to the latex component, when the latex composition is heated, it will generate moisture or form a carbon coating film, and form a bubble-containing fireproof coating to increase flame retardancy. The above-described fireproof elastic coating material is used in such an amount that the liquid acrylic latex or synthetic rubber latex composition can exhibit flame retardancy grade 3 according to KS F 2271:1998 (flame retardancy tests of building interior materials and structures and pass a noxious gas test.

In another embodiment of the present invention, the packing material (P) for firestop systems further comprises a heat-resistant core material 300. The heat-resistant core material 300 is provided in the thermal insulation material layer 100 in a given shape. FIG. 4 illustrates a packing material (P) for firestop systems, which comprises the heat-resistant core material 300. As shown in FIG. 4, the heat-resistant core material 300 is in the form of dots, columns or sheets, which are arranged in the thermal insulation material 100 in a given interval.

As described above, in order for through-penetrations to be lawfully recognized as firestops, the through-penetrations must pass a given heat resistance test and hose stream test till 1-2 hours depending on fire resistance ratings (F and T). When the heat-resistant core material 300 is formed in the thermal insulation material layer 100, the heat-resistant core material 300 will prevent the burning of the thermal insulation material layer 100 during a sample heating process, prevent the removal of the layer 100 and act as a support against water pressure during a hose stream test.

The reason why the heat-resistance core material 300 is arranged in the thermal insulation material layer 100 at a given interval is because of heat resistance and constructability. As shown in FIG. 8, in order to fill the gap of an irregular slab plane, an operation of pressing the packing material (P) by about 25-35% and inserting the compressed packing material tightly into the through-penetration of the slab is carried out during a construction process. The packing material (P) containing the heat-resistant injection material shows better performance as the area of the heat-resistance core material 300 increases, but after it is dried, the elasticity thereof is reduced as much, and thus it is difficult to insert the packing material tightly. However, when the thermal insulation material layer 100 having elasticity, and the heat-resistant core material 300, which has excellent heat resistance but shows relatively low elasticity, are suitably disposed, heat resistance and elasticity can be simultaneously satisfied. Thus, when the amount of injection of the heat resistant injection material, the blending ratio of raw materials and the area of the heat-resistant core material 300 are varied during the manufacture of the packing material (P), construction satisfying fire resistance ratings can be performed by using the existing specifications of the packing material (P) without separate processing, and also wide penetrations that require high heat resistance can be effectively filled with the packing material.

The heat-resistant injection material, which is used for forming the heat-resistant core material 300, comprises liquid silicate, and examples of the liquid silicate include sodium silicate, potassium silicate and lithium silicate. Also, the heat-resistant injection material further comprises at least one selected from among powder-type aluminum hydroxide (Al(OH)₃), sepiolite (Si₁₂Mg₃O₃₂H₂O) and talc (magnesium silicate hydroxide (Mg₃Si₂O₁₀(OH)₂). Preferably, the heat-resistant injection material comprises, as a binder, 52 wt % of liquid sodium silicate (42% solids; Na₂O.nSiO₂.xH₂O), and as fillers, 24 wt % of sepiolite, 8 wt % of aluminum hydroxide and 16 wt % of talc (composition 2). Such a composition prevents liquid sodium silicate being condensed during a high-temperature heating process when the liquid sodium silicate is used alone. Also, the composition increases the shape retention and heat resistance of the heat-resistant core material 300. Thus, the packing material (P) will have heat resistance capable of withstanding a temperature of 1100° C. for 3 hours or more.

FIG. 5 shows that the packing material (P) for firestop systems according to the present invention are overlapped with each other or split for use. The left side of FIG. 5 illustrates the case where two or more packing materials (P) of the present invention are overlapped with each other for use, and the right side illustrates the case where the packing material (P) is split for use. The split packing materials (P) can be overlapped with each other for use as shown in the left side of FIG. 5.

Meanwhile, the right side of FIG. 5 illustrates that the packing material (P) for firestop systems is split into two or more according to the dimension of a through-penetration, when the dimension of the packing material (P) is greater than the width of the through-penetration.

In another embodiment of the present invention, the packing material for firestop systems is formed by forming the fireproof coating film 200 on the surface of the thermal insulation material layer 100, which does not include the heat-resistant core material 300 therein, and stacking the resulting structures on each other. This embodiment can show the same effect as that of the embodiment where the heat-resistant core material 300 is disposed in the thermal insulation material layer 100.

2. Method for Manufacturing Packing Material for Firestop Systems

The thermal insulation material layer 100 is cut to a suitable width in consideration of the size of a building through-penetration, and then is subjected to a pressing process in order to give elasticity when the thermal insulation material layer is made of an inorganic insulation material such as mineral wool. FIG. 6 illustrates the pressing process. In FIG. 6, reference numeral denotes a press, 701 a pressing die, and 702 a pressurizer. As the thermal insulation material of the thermal insulation material layer 100, a high-density product is mainly used in order to reinforce the heat resistance thereof, and in the case of mineral wool having a density of more than 100 K, it is impossible for workers to press and insert the thermal insulation material into through-penetrations directly in situ.

For this reason, the thermal insulation material layer 100 is rendered elasticity through the pressing process, such that workers can easily perform the construction work of firestops using the packing material (P). When the thermal insulation material layer 100 such as mineral wool, in which fine inorganic cellulose tissues having a size of 5-10 microns are bound to each other in an amorphous form, is pressed in the direction opposite to the texture thereof with vibration, the binding force of the amorphous cellulose tissues becomes weak while the thermal insulation material layer 100 will have elasticity. The thermal insulation material layer subjected 100 to the pressing process will not exhibit sufficient restoring force due to the reduction in the binding force of fine inorganic cellulose tissues. For this reason, when the above-described fireproof elastic coating material is applied on the thermal insulation material layer to form the fireproof coating film 200, the restoring force will be increased.

Also, the above-described pressing process may also be carried out immediately after the heat-resistant injection material is injected into the thermal insulation material layer 100. In this case, the injection material is absorbed into the thermal insulation material during the pressing process, and thus the injection material has a reduced effect on the elasticity of the thermal insulation material layer 100, even after it is dried. The above-described pressing process is not applied to polyester-based thermal insulation materials, and is applied only to inorganic fibers, including mineral wools, glass wool, Cerak wool, vermiculite wool and the like.

When the liquid-type heat-resistant injection material is injected into the thermal insulation material layer 100 having absorption ability, at a given interval, the heat-resistant core material 300 is formed. FIG. 7 shows that the heat-resistant injection material is injected into the thermal insulation material layer 100 to form the heat-resistant core material 300. As shown in FIG. 7, injection pins 401 are arranged on a core material-forming frame 400 at a given interval. The arranged injection pins 401 are thrust into the thermal insulation material layer 100, and then taken out from the insulation material layer, while the heat-resistant injection material is injected into the thermal insulation material layer 100 through the end portions of the injection pins 401, thus forming the heat-resistant core material 300 in the form of columns, dots or sheets. The number and dimension of the injection pins 401 can be adjusted according to the viscosity of the injection material and the fire resistance performance of the packing material (P), and the arrangement of the heat-resistant core material 300 can be determined according to the arrangement of the injection pins 401. The heat-resistant core material 300 may be formed in an irregular shape depending on the viscosity of the injection material and the density of the thermal insulation material layer 100.

The fireproof coating film 200 is formed by applying a fireproof elastic coating material on the surface of the thermal insulation material layer 100. When the fireproof elastic coating material is applied subsequently to the formation of the heat-resistant core material 300, but before the drying of the injection material of the heat-resistant core material 300, the phenomenon that the injection material of the heat-resistant core material 300 is dried can be prevented during a considerable period of time before construction work. Thus, when the packing material (P) for firestop systems is subjected to a pressing process in order to insert the packing material into a through-penetration as shown in FIG. 8, the heat-resistant injection material present as the liquid state in the thermal insulation material layer 100 will be absorbed into the thermal insulation material around the heat-resistant core material 300. As a result, the area of the heat-resistant core material 300 can be enlarged and the heat-resistant core material 300 can be formed into a shape similar to the inner structure of the through-penetration, thus further increasing heat resistance.

Meanwhile, the method of the present invention may also be performed in a reversed order. Specifically, the packing material for firestop systems can be provided by applying the fireproof elastic coating material, comprising liquid latex and flame-retardant materials, on the surface of the thermal insulation material layer, to form a fireproof coating film, injecting the heat-resistant injection material into the thermal insulation material layer to form a heat-resistant core material in the form of any one of columns, dots or sheets. In this case, when the thermal insulation material layer is an inorganic thermal insulation material made of any one of mineral wool, glass wool, ceramic (Cerak wool), vermiculite wool and pearlite wool, it is subjected to a pressing process, in which it is pressed and vibrated so as to have elasticity.

3. Method for Applying Packing Material for Firestop Systems

FIGS. 8 and 9 show that the packing material (P) for firestop systems is applied.

FIG. 8 shows that the packing material (P) for firestop systems is pressed and inserted. The packing material (P) for firestop systems, which was manufactured according to specifications in a factory, is transferred to a construction site and, as shown in the left side of FIG. 8, it is pressed by about 30% and inserted into the opening 601 of a concrete structure 600. The pressing rate of the packing material (P) for firestop systems is in a range of about 25-35%. The right side of FIG. 8 shows a finish process in which a water-sealing coating material 500 having flame retardancy is applied in order to seal the gap between the concrete structure 600 and the packing material (P) for firestop systems. However, if the water-sealing construction process is not required, the finish process may also be performed by applying the fireproof elastic coating material that is used to form the fireproof coating film 200 on the surface of the thermal insulation material layer 100.

FIG. 9 shows a method of cutting a roll-type packing material (P) for firestop systems in order to apply the packing material (P) to the gap between a pipe and a slab in a through-penetration and shows that the packing material (P) is applied to the gap. As the width of the through-penetration decreases, it is difficult to insert the packing material (P) into a through-penetration, and even after it is inserted, the connection thereof is out of line, such that the high and low of the connection are not consistent with each other. However, as shown in FIG. 9, when the packing material (P) for firestop systems is cut with the same angle at both ends, and then thrusts against the outer surface of the pipe, the packing material (P) for firestop systems is formed into a cylindrical shape, so that the high and low of the connection is conveniently adjusted and the phenomenon that the packing material is bent or rolled is prevented.

### BRIEF DESCRIPTION OF THE DRAWINGS

FIGS. 1 and 2 are cross-sectional views showing the construction of the prior firestop systems.

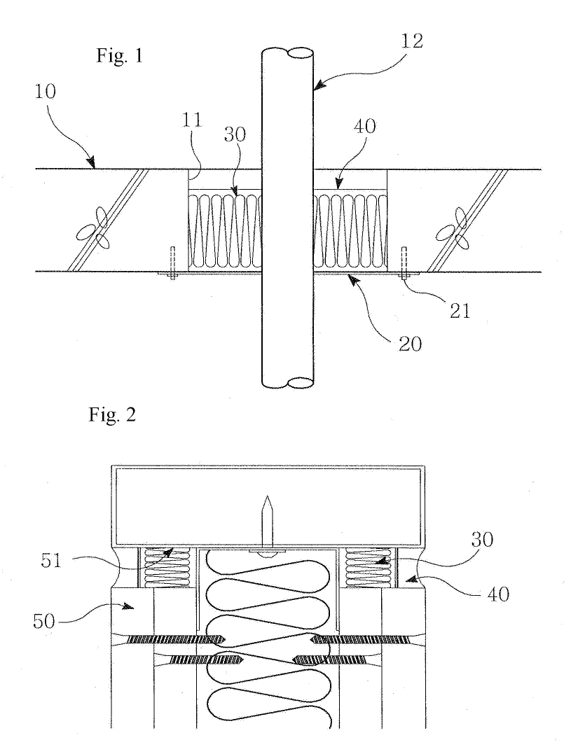

FIG. 3 shows various configurations of the inventive packing material for firestop systems.

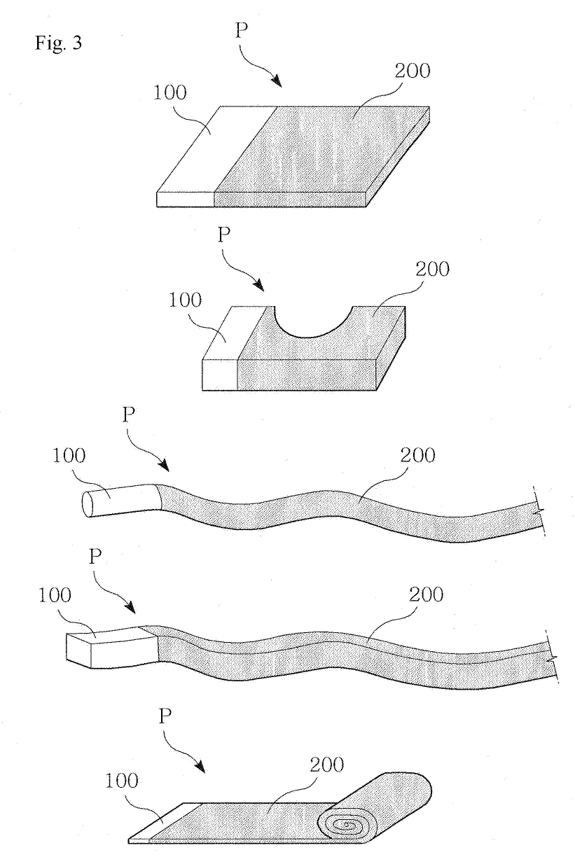

FIG. 4 illustrates the inventive packing materials for firestop systems, which have various configurations of heat-resistant core materials.

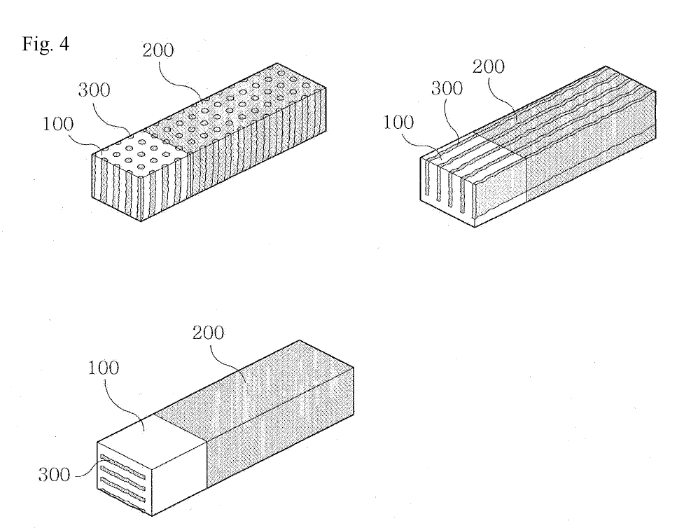

FIG. 5 illustrates the use of inventive packing material for firestop systems.

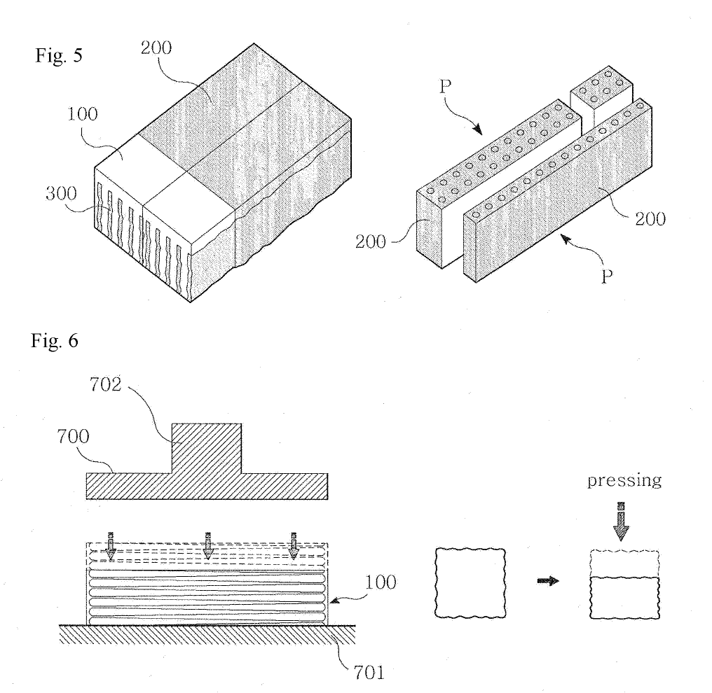

FIGS. 6 and 7 show a process for manufacturing the inventive packing material for firestop systems.

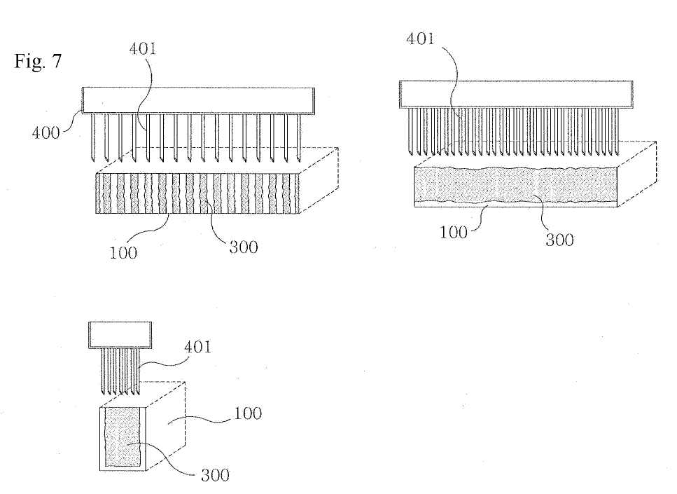

FIGS. 8 and 9 show a method of applying the inventive packing material for firestop systems.

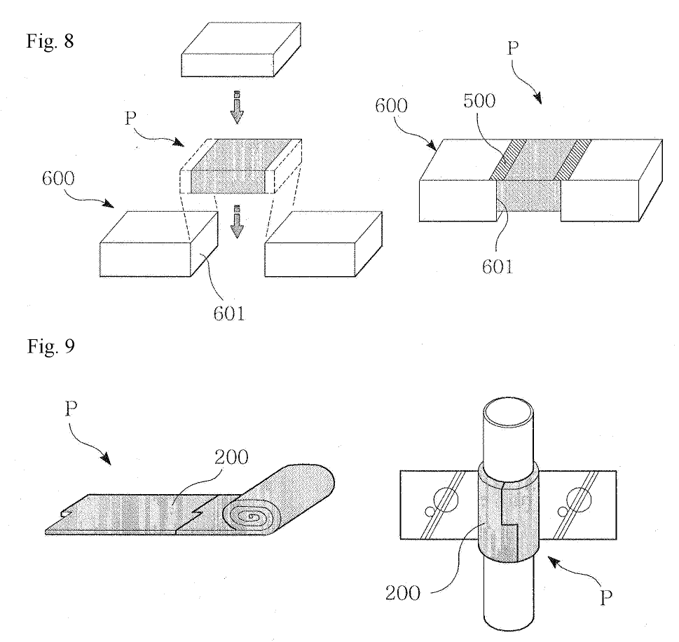

FIG. 10 shows the heat shrinkage curve versus volume of the inventive packing material for firestop systems and mineral wool as a control group.

### DESCRIPTION OF MAIN REFERENCE NUMERALS USED IN THE DRAWINGS

100: thermal insulation material layer;
200: fireproof coating film;
300: heat-resistant core material;
500: water-sealing coating material having flame retardancy;
601: opening of concrete structure; and
P: packing material for firestop systems.

### MODE FOR THE INVENTION

### Heat Resistance Test and Hose Stream Test of Packing Material for Fire Systems

Firestop systems should undergo fire resistance tests up to a maximum of 2 hours depending on fire preventive partitions, and the test items are divided into a heat resistance test and a hose stream test.

As a test control group (a), mineral wool (100K, KCC Corporation, Korea), which has been frequently as an intermediate material, was used, and as a test group (2), a packing material (A) for firestop systems was used, which was formed by injecting the heat-resistant injection material having the composition (2) as disclosed in the detailed description of the invention, into a 100K mineral wool, in an amount of 20% relative to the volume of the mineral wool, to form a heat-resistant core material 300 in the form of columns arranged at a given interval, and applying the coating material having the composition (2) as disclosed in the detailed description of the invention, to form a fireproof coating film 200.

(1) Heat Resistance Test

When a test sample is heated at controlled temperature under the same conditions as the standard time-temperature curves provided in FS 012 (fire test methods for firestops) 3.1.4. (heating testing), the test sample will be degraded while it will come off with shrinkage.

The control group (a) and the test group (b) were heated in a test furnace to 1,016° C., and the shrinkage (%) of the samples was measured for the comparison of degradation between the samples. The density of the samples was 100K and the dimension was 100×100×100 mm. With respect to a burning line (c), when a comparative product was pressed by 130%, it was experimentally confirmed that, at a test sample shrinkage of less than 10%, the test sample did not come off during heating, and thus a shrinkage limit causing the coming off of the test sample during heating was set at 10% relative to the volume of the test sample and was determined as a reference.

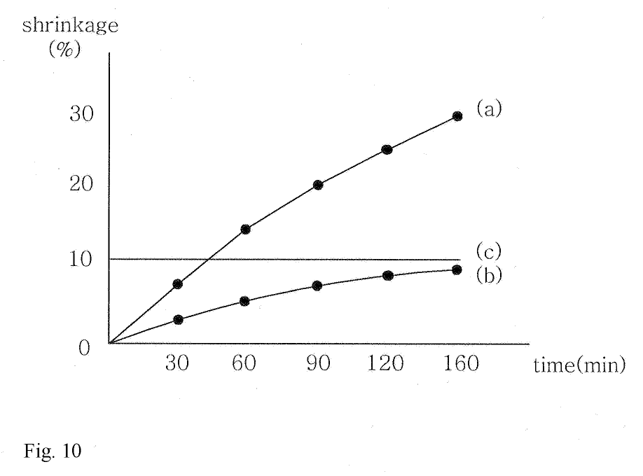

FIG. 10 and Table 1 show the thermal shrinkage (%) versus of the control group (a) and the test group and revealed that the packing material (P) for firestop systems did not come off during a given period of time, and thus passed the heat resistance test.

Table 1

TABLE 1
thermal shrinkage (%) versus volume

| Heating time (min) | 30 | 60 | 90 | 120 | 160 |
|---|---|---|---|---|---|
| (a) control group (mineral wool) | 7 | 14 | 19 | 24 | 28 |
| (b) test group (packing material for firestop | 3 | 5 | 7 | 8.5 | 9 |
| systems) | | | | | |

(2) Hose Stream Test

Firestop systems require higher fire resistance as the width of through-penetrations increases. This is because, if the through-penetration is wide as much, it will undergo much thermal resistance and hose stream pressure. The width of a through-penetration in a firestop system comprising mineral wool as an intermediate material is generally about 100 mm.

In this test, in order to compare hose stream pressure, each of the control group (a) (mineral wool) and the test group (packing material for firestop systems) was pressed by 130% and disposed in a through-penetration (ALC panel). The surface opposite to the heating surface is subjected to a water-sealing process for waterproof purposes, in which a water-sealing coating material 500 having flame retardancy was applied on one surface of the packing material (P), opposite to the heating surface, including a slab surface (20 mm overlap) adjacent to the packing material (P), to a thickness of 1 mm (dry thickness), to form a coating film. Thus, because the fireproof elastic coating material was already applied on the entire surface of the test group (packing material (P) for firestop systems) to a thickness of 2 mm, the surface opposite to the heating surface of the packing material (P) for firestop systems had a total coating thickness of 3 mm, including the water-sealing coating material. The dimension of the through-penetration was set

at a depth of 1 m and a width of 100 mm, and the width was gradually increased. The samples were heated in a heating furnace for 2 hours.

Also, the samples were subjected to a hose stream test for 5 min using a 12.7-mm diameter nozzle under a discharge pressure of 1.40 kg/cm² at a distance of 5 m, as provided in FS 012 (fire test method for firestop systems) 3.2. (hose stream test). As a result, whether a hole was formed through the non-heated surface was observed and the samples were divided into pass (◯) and rejection (x).

Table 2

TABLE 2
Hose stream test results according to through-hole sizes

| Through-penetration width (mm) | 50 | 100 | 150 | 200 | 250 |
|---|---|---|---|---|---|
| (a) control group (mineral wool) | ∘ | ∘ | | | |
| (b) test group (packing material for | ∘ | ∘ | ∘ | ∘ | ∘ |
| firestop systems) | | | | | |

### INDUSTRIAL APPLICABILITY

As described in detail above, the effects of the inventive packing material (P) for firestop systems are as follows:

First, because the fireproof coating film 200 is formed on the surface of the thermal insulation material layer 100, it increases the flame retardancy, waterproof, abrasion resistance, dust resistance and restoring force of thermal insulation material layer 100. Also, because the thermal insulation material layer 100 is subjected to a pressing process so as to have elasticity, it can be tightly inserted into through-penetrations.

Second, the heat-resistant core material 300 formed in the thermal insulation material layer 100 prevents the degradation of the thermal insulation material layer 100, prevents the layer 100 from coming off due to shrinkage during heating and acts as a support against water pressure in a hose stream test.

Third, fire resistance rating can be adjusted by varying the injection amount of the heat-resistant injection material, the blending ratio of raw materials and the size of the heat-resistant core material 300, and quality construction work becomes possible by adjusting the heat resistance and compressibility of the packing material depending on the width of through-penetrations.

Fourth, because the fireproof elastic coating material is applied to form the fireproof coating film 200 before the heat-resistant injection material is dried. Thus, the heat resistance and constructability of the packing material are increased, such that the packing material is also suitable for use in wide penetrations.

Fifth, unskilled persons can carry out construction work using the packing material, and the number of work processes is greatly reduced, thus reducing labor cost. Also, because an expensive firestop material is not used, construction cost can be reduced by about 40% or higher compared to the prior construction work, and the construction period can be shortened to half the prior construction. In addition, the inventive packing material solves the problem that the outdoor work in the winter season or the case of rain is impossible.

Sixth, because a product, which comprises the fireproof coating film 200 formed on the thermal insulation material layer 100 and is manufactured and standardized in a factory, is used in construction sites, the generation of industrial waste such as mineral wool is inhibited and workers are prevented from being damaged by mineral wool dust in construction sites. In addition, the external exposure of thermal insulation material such as mineral wool is blocked to prevent indoor air being contaminated with mineral wool dust, thus providing a pleasant indoor environment to house occupants.

1. A packing material for firestop systems, which comprises a thermal insulation material layer made of any one selected from among ceramic wool, mineral fiber-based insulation material and polyester-based insulation material; and a fireproof elastic coating film, which is formed by applying, on the surface of the thermal insulation material, a fireproof elastic coating material comprising liquid latex and a flame retardant.

2. The packing material for firestop systems, wherein the thermal insulation material layer having the fireproof coating film applied thereon is stacked in plurality.

3. The packing material of claim 1, further comprising a heat-resistant core material, which is formed in the thermal insulation material layer in the form of any one of columns, dots and sheets at a given interval.

4. The packing material of claim 3, wherein the heat-resistant core material is formed by injecting, into the thermal insulation material layer, a heat-resistant injection material, which comprises inorganic liquid silicate and at least one selected from among powder-type aluminum silicate, aluminum hydroxide, sepiolite, talc and calcium carbonate.

5. A method for manufacturing a packing material for firestop systems, the method comprising the steps of:
(1) cutting a thermal insulation material layer made of any one of ceramic wool, mineral fiber-based insulation material and polyester-based insulation material, such that the cut thermal insulation material layer meets specifications;
(2) injecting a heat-resistant injection material into the thermal insulation material layer to form a heat-resistant core material in the form of any one of columns, dots and sheets; and
(3) forming, on the surface of the thermal insulation material layer, a fireproof elastic coating material, which comprises liquid latex and a flame retardant.

6. A method for manufacturing a packing material for firestop systems, the method comprising the steps of:
(1) cutting a thermal insulation material layer made of any one of ceramic wool, mineral fiber-based insulation material and polyester-based insulation material, such that the cut thermal insulation material layer meets specifications;
(2) forming, on the surface of the thermal insulation material layer, a fireproof elastic coating material, which comprises liquid latex and a flame retardant; and
(3) injecting a heat-resistant injection material into the thermal insulation material layer to form a heat-resistant core material in the form of any one of columns, dots and sheets.
